(19) United States
(12) Patent Application Publication
(10) Pub. No.: US 2006/0182438 A1
(43) Pub. Date: Aug. 17, 2006

(54) Battery fixing structure

(75) Inventors: Goichi Odo, Saitama (JP); Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/352,229

(22) Filed: Feb. 13, 2006

(30) Foreign Application Priority Data
Feb. 14, 2005 (JP) 2005-035469

(51) Int. Cl. G03B 17/00

(52) U.S. Cl. 396/439

(57) ABSTRACT

A battery fixing structure used in a battery housing structure that houses a battery in a battery case and which makes terminals of the battery electrically contact with contact pieces provided in the battery case. The battery fixing structure comprises a fastening belt that is looped so as to fit around a periphery of the battery when one end of the fastening belt is pulled, while the other end of the fastening belt is fixed to the battery case.

### BACKGROUND OF THE INVENTION

1. Field of the Invention

The present invention relater to a mechanism that fixes a battery inside a battery case. Particularly, the invention relates to a fixing structure that prevents instantaneous disconnection between a contact piece and a battery terminal, which is caused by a movement of the battery induced by impact or oscillations.

2. Description of the Related Art

In recent electronic instruments, including portable electronic instruments and cameras, which use a battery power source, electronic circuits are reset when the battery installed inside the battery case, is disconnected from a battery terminal. Particularly, regarding cameras, photograph data is lost when the power supply from the power source is interrupted while writing the photographing data in a memory card. Therefore, in these types of electronic instruments, users are warned that not to replace a battery while the power switch is on. Further, when the battery door of the battery case is opened by mistake while the power switch is on, so as to replace a battery, measures that force the power switch to be turned off are taken.

A battery case for an electronic instrument of the type that uses a dry cell having a cylindrical shape and positive and negative terminals on both ends, including a dry cell of the size AA or the size AAA, is provided with contact pieces that springily contact the positive and negative terminals. Namely, the dry cell is retained due to the spring forces of each of the contact pieces, while electric contact is maintained with each of the positive and negative terminals because of the spring forces of each of the contact pieces. In this type of battery case, since the battery is elastically retained by the spring actions of the contact pieces at terminals at both ends in the longitudinal direction, contact between the contact pieces and the terminals of the battery is unstable if spring forces of the contact pieces are small. Thereby, the battery can be easily moved by impact or oscillation from the outside, so that the contact between the contact pieces and the battery terminals can be intermittently disconnected without warning. On the other hand, when the spring forces of the contact pieces are increased, a large force is required for installing the battery inside the battery case, so that it is hard to put in and take out the battery from the battery case. Further, even if the spring forces of the contact pieces are increased, it would still be hard to avoid disconnection, since there is still the possibility of the battery being subjected to an acceleration larger than the spring force depending on the magnitude of an external impulse.

As for the problems regarding the intermittent disconnection of the battery, Japanese Unexamined Patent Publication No. 2004-87134 discloses a structure that is provided with a plurality of independent terminals (contact pieces) having a curved contact section which contacts the battery, and each terminal having an independent biasing member which bears the contact section upon the battery. In this way, the terminals follow the motion of the battery and electric contact at each terminal is secured.

### SUMMARY OF THE INVENTION

Although, the above structure disclosed in the Japanese Unexamined Patent Publication No. 2000-87134 has a plurality of contact pieces that independently contact with a terminal of the battery, the electrical contact with the terminal still relies on the spring force of the contact pieces, as is similar to the above-discussed prior art. Therefore, it can be difficult to prevent electrical disconnection between the terminals, depending on the amount of force induced on the battery due to a rapid acceleration from an impact. Particularly, when the above structure is used in the battery case of a camera, which uses a dry cell as a power source, acceleration of the dry cell becomes quite large when a large external impact or oscillation occurs. When a large force from a rapid acceleration is induced, the battery is moved beyond an elastically deformable range of the contact piece, so that electrical disconnection occurs on the side opposite to the battery motion. When the spring force of each of the contact pieces is strengthened in order to prevent this disconnection, the ease of installation is reduced as described above. Especially, for the type of battery case in which the batteries are installed inside the battery case by a sliding operation, one has to urge one terminal of the battery upon the corresponding contact piece and deform the contact piece in order to put the battery in place. Accordingly, the installation of the battery becomes difficult since a large deforming force is required to deform the contact piece. The same is true when removing a battery from the battery case, so that it is quite hard to remove a battery in the above-discussed structure.

Further, there is also provided a structure that uses elastic material (including rubber and sponge). In this structure, the elastic material is provided on the battery door of the battery case, so that the elastic material presses the side surface of the battery when the battery door is closed. However, this structure is mainly used to prevent rattling in the lateral direction of the battery and to keep the battery in place, between the contact pieces. Although the structure has some effect in preventing battery motion in the longitudinal direction, it still can not provide a large bearing force against the battery, so that it is inadequate for preventing disconnection between the battery and the contact piece, by effectively preventing motion of the battery due to an external impulse and the like.

Therefore, according to the present invention, a battery fixing structure is provided that is able to securely prevent an electrical disconnection of a battery, without restricting battery installation/removing capability.

The battery fixing structure is used in a battery housing structure. The battery housing houses a battery in a battery case and makes terminals of the battery electrically contact with contact pieces provided in the battery case. The battery fixing structure comprises a fastening belt that is looped so as to go round a periphery of the battery when one end of the fastening belt is pulled, while the other end of the fastening belt is fixed to the battery case.

### BRIEF DESCRIPTION OF THE DRAWINGS

The objects and advantages of the present invention will be better understood from the following description, with reference to the accompanying drawings in which:

FIG. 1 is a general perspective view of an embodiment, in which the present invention is applied to a battery grip of a camera;

FIGS. 2A and 2B are a plan view and an elevational cross sectional view of the battery grip, where a part of the battery grip is removed;

FIG. 3 is a partially exploded perspective view of a contact piece structure and a battery fixing structure assembled on an inner base plate inside the grip body;

FIGS. 4A and 4B are plan views of the fastening belt and a rotational mechanism viewed from the bottom side;

FIG. 5 is a partial exploded view illustrating a main part of the rotational mechanism; and

FIGS. 6A-6C illustrate conditions of the dry cells fastened by the fastening belt.

### DESCRIPTION OF THE PREFERRED EMBODIMENTS

The present invention is described below with reference to the embodiments shown in the drawings

A fastening belt is formed so that one end side in the belt's longitudinal direction, is wider than the other end side. The one end side is provided with a slit opening through which the other end side is insertable. The other end side is inserted into the slit opening and forms a loop. Thereby, a symmetric fastening force is provided in the belt width direction when the fastening belt is fastened, so that the peripheral surface of the battery is clamped and the battery can be retained in a stable manner. Further, at one end of the fastening belt, an absorbing section is provided, in which the fastening belt is bent in the thickness direction in order to give a springy characteristic to the fastening belt in the longitudinal direction. Thereby, the battery can be suitably fastened by the springy act of the absorbing section regardless of whether the fastening force is too large or too small.

A rotational mechanism is provided with a fastening knob which is manually rotated, so that at fastening shaft is rotated by the rotational operation of the fastening knob. Further, the rotational mechanism is provided with a stop mechanism that engages with, and stops, the fastening shaft, being rotated in the opposite direction. The stop mechanism is structured so that the mechanism for releasing the engagement with the fastening shaft that prevents the opposite rotation, is released when the fastening shift is rotated in the opposite direction by manually rotating the fastening knob. Thereby, the battery can be fastened or released by the fastening belt, in accordance with manual operations of the fastening knob.

For example, the battery housing structure, in which the inventive battery fixing structure is applied, is formed as a battery grip, which is attached to a camera by using a tripod female screw hole of the camera. In this case, the fastening knob is formed as a tripod male screw for attaching the battery grip to the camera. Further, a dry cell, of which an example is a size AA battery having terminals on both side ends in the longitudinal direction, is adopted as the battery in the embodiment, and the fastening belt fastens a part of the dry cell along the longitudinal direction thereof.

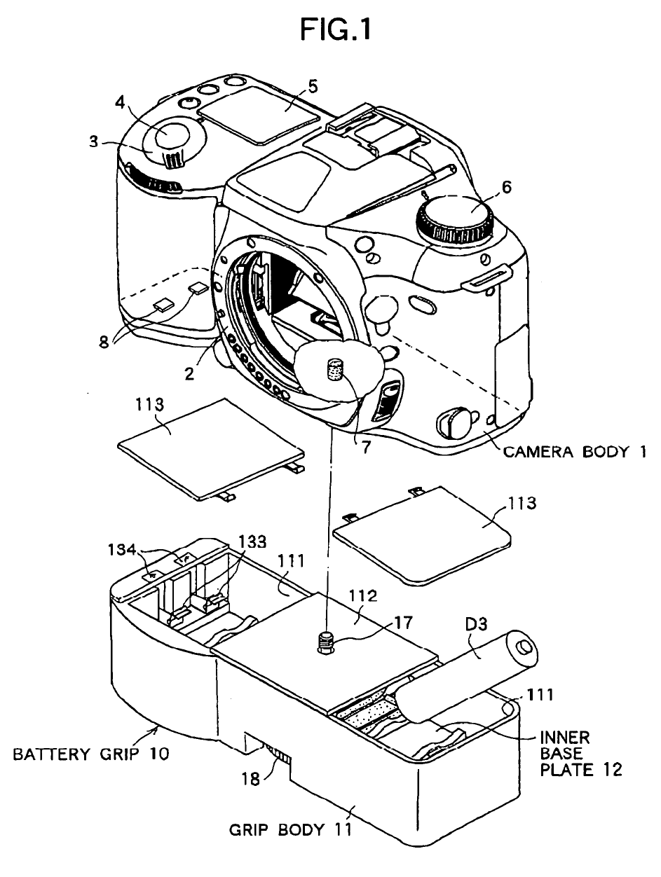

Next, the embodiments of the present invention will be described below with reference to the drawings. FIG. 1 is a general perspective view of a first embodiment, in which the inventive battery fixing structure is applied to a battery grip of a digital single-lens reflex camera of an interchangeable-lens type, as a battery case on the front face of a camera body 1, a lens mount 2 for mounting a photographing lens (not depicted) is provided. Further, on the top face of the camera body 1, a main switch 3 of a rotational lever type, a depressible release button 4, an LCD 5 for indicating photographing information, and a mode dial 6 for selecting a photographing mode. On the bottom face of the camera body 1, a tripod female screw hole 7 and body-side terminals 8, which are transparently illustrated, are provided. A battery case, which houses batteries for a secondary power source of the camera, is formed as battery grip 10 in the present embodiment, and is attached to the bottom face of the camera body 1 by using the tripod female screw hole 7, so that a pair of battery-side terminals 134, which is exposed on the top face of the battery grip 10 at one end of the grip in the longitudinal direction, contacts with the body-side terminals 8 on the camera body 1 and is electrically connected thereto, when the battery grip 10 is installed on the camera body 1. As mentioned above, the battery grip 10 is a supplemental power source that is used to supplement the capacity of the power source (not shown) inside the camera body 1. At the same time, the battery grip 10 also facilitates support of the camera in a lateral or portrait position, when holding the battery grip 10 in one hand.

In this embodiment, the battery grip 10 is configured to be capable of loading four dry cells D3 of the size AA. An inner base plate 12 is fixed inside a narrow box shaped grip body 11. As will be described later, a contact piece structure 13 for receiving the dry cells D3 and a battery fixing structure 14 are assembled on the inner base plate 12. On the top face of the grip body 11, openings 111 are formed at both side ends in the longitudinal direction. Namely, the dry cells D3 are installed in or removed from the grip body 11 through each opening 111. Further, a tripod male screw 17 penetrates a top plate 112 of the grip body 11, which is disposed at the center of the grip in the longitudinal direction, from the bottom face of the battery grip 10 and protrudes upward. The battery grip 10 is attached and integrated with the camera body 1 by screw engagement of the tripod male screw 17 to the tripod female screw hole 7. The screw engagement is carried out by rotating a tripod fastening knob 18 (having a large diameter) provided on the bottom face of the battery grip 10 and thus rotating the tripod male screw 17. Note that, each of the openings 111 on the top face can be sealed by battery doors 113 that are attached to or detached from, the battery grip 10.

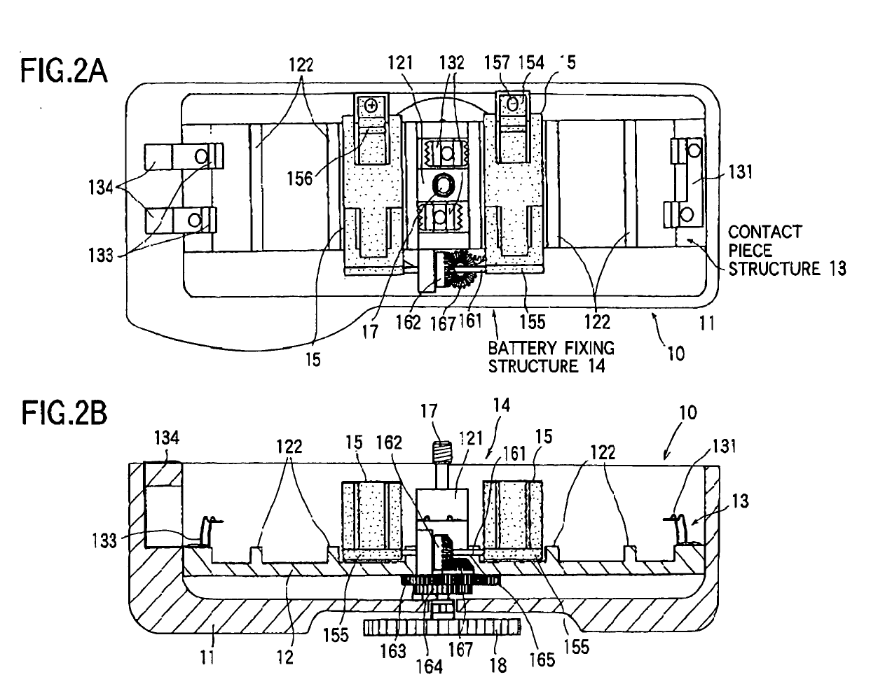

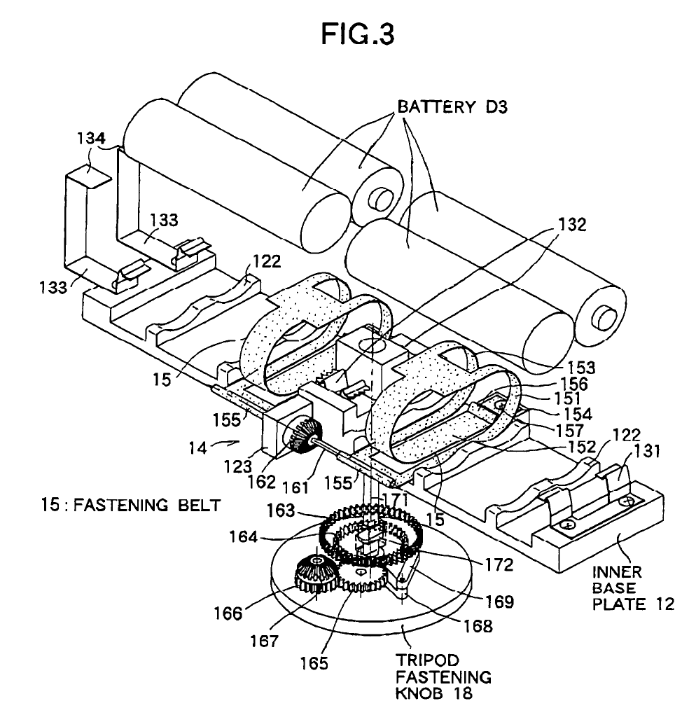

FIG. 2A and FIG. 2B are respectively a plan view and elevational cross sectional view of the battery grip 10, when the top plate 112 is removed. FIG. 3 is a partially exploded perspective view of the contact piece structure 13 and the battery fixing structure 14 assembled on the inner base plate 12, inside the grip body 11. The inner base plate 12 is formed as a narrow plate configuration corresponding to the shape of the grip body 11 of the battery grip 10. A boss 121 is erected at the center of the top face in the longitudinal direction. The tripod male screw 17 penetrates through an insertion bore that pierces, in vertical direction, through the boss 121. The tripod fastening knob 18 is integrally provided on the bottom end of the shaft 171 (discussed later) of the tripod male screw 17.

The contact piece structure 13 is provided on the upper surface of the inner base plate 12. Battery-bearing ribs 122 (herein six), of which the upper edge is formed like a wave to support the dry cells D3, are disposed at a predetermined interval on both sides of the inner base plate 12 in the longitudinal direction. Each of four dry cells D3 loaded inside the battery grip 10 are supported on three battery-bearing ribs 122, which are aligned in the longitudinal direction, with four of the dry cells D3 disposed in a coplanar arrangement with two in the length direction and two in the width direction. Further, at the center of the upper surface of the inner base plate 12 and at both ends of the upper surface of the inner base plate 12 in the longitudinal direction, contact pieces 131, 132, and 133, which are formed by bending a springy metallic plate, are fixed. Each of the contact pieces 131, 132, and 133 bears upon and contacts with each of the positive and negative terminals of the dry cells D3 (which are supported by the battery bearing ribs 122) due a spring force, whereby four dry cells D3 are electrically connected in series. Among the contact pieces 131 to 133, the contact piece 133, which is arranged at one end of the inner base plate 12, includes a pair of mutually independent contact pieces 133. Each of the contact pieces 133 is extended up to the upper surface of the grip body 11. The distal end portions of each of the contact pieces 133 are bent along the upper surface and configured as the battery-side terminals 134.

The battery fixing structure 14 comprises two fastening belts 15 and a rotational mechanism 16. The fastening belts 15 are arranged in the areas between the central portion and the two battery-bearing ribs 122, which are disposed closest to the center among three battery-bearing ribs 122 arranged on both sides of the central portion along the longitudinal direction of the inner base plate 12. The rotational mechanism is used to fasten the fastening belts 15. The two fastening belts are structured the same way. Namely, the fastening belts are made of a thin steel plate that is configured as a belt. One end side portion 151 of the fastening belt is configured wider than the other end side portion 152, and one end side portion 151 is provided with a slit opening 153, into which the other end side portion 152 ix insertable. Further, in a position nearby the other end 154 of each fastening belt 15, an absorbing section 156 is provided, which is triangularly bent in the belt thickness direction the other end 154 is inserted into the slit opening 153 and each of the fastening belts 15 are rounded and looped in the belt thickness direction. Further, the fastening belts 15 are oriented in a direction perpendicular to the longitudinal direction of the inner base plate 12, so that the other end 154 is fixed on one side of the upper surface of the inner base plate 12 by a screw 157 and the one end 155 of each fastening belt 15 is connected to the fastening shaft 161 of the rotational mechanism 16, which extends along the other side of the inner base plate 12.

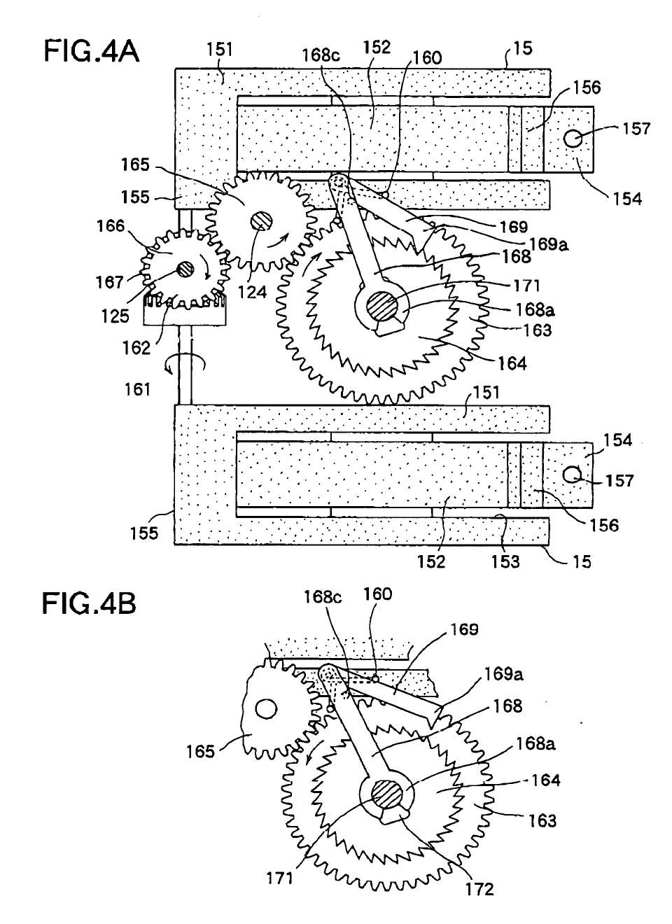

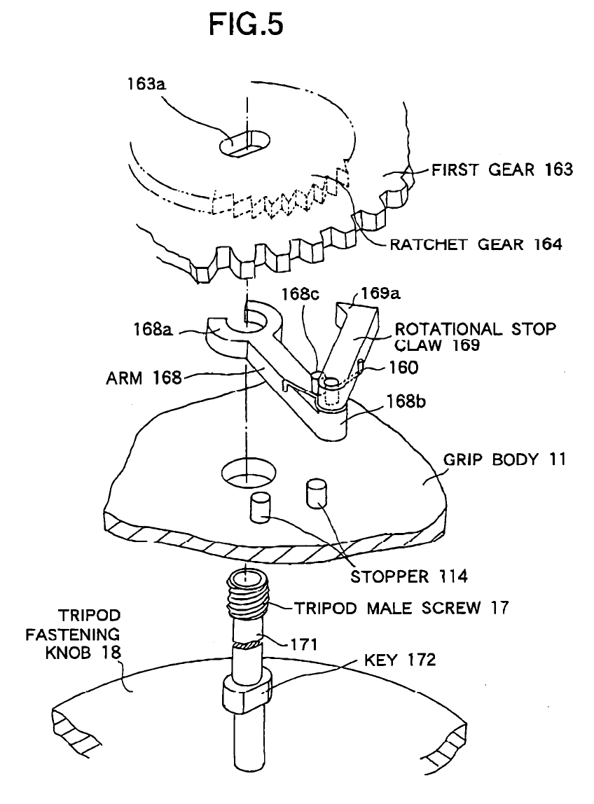

The rotational mechanism 16 is structured to be cooperative with the tripod male screw 17 and the tripod fastening knob 18. FIGS. 4A and 4B are plan views of the fastening belt 15 and the rotational mechanism 16 viewed from the bottom side, and FIG. 5 is a partial exploded view illustrating a main part thereof. The fastening shaft 161, which is connected to the one end 155 of each fastening belt 15, is rotatably journaled by a bearing 123, which is integrally provided on one side of the inner base plate 12. A bevel gear 162 is integrally fixed at substantially the center of the fastening shaft 161. When the fastening shaft 161 is rotated, the one end 155 of each fastening bolt 15 is wound around the axis, so that the loop diameter of the fastening belts 15 can be reduced. Further, a key 172 is integrally provided on a part of a shaft 171 (in the longitudinal direction) of the tripod male screw 17, so that a first gear 163 having a large diameter and a keyhole 163a that fits the key 172 is rotatably supported about the shaft 171. The first gear 163 is integrally provided with a ratchet gear 164, having a saw tooth-shaped profile with a rather small diameter, on the backside. Further, a second gear 165 is engaged with the first gear 163, and the second gear 165 is engaged with a third gear 166. The second gear 165 and the third gear 166 are rotatably journaled to fixed axes 124 and 125, which are erected on the inner base plate 12. Further, the third gear 166 is integrally provided with a beveled gear 167, which is engaged with the beveled gear 162. Thereby, when the tripod male screw 17 is rotated, the key fitting first gear 163 is rotated, and in turn, the second gear 165 and the third gear 166 are rotated, so that the beveled gear 162 is rotated and the fastening shaft 161 is rotated in turn, and thereby, the fastening belts 15 are wound.

Further, a proximal end portion 168a of an arm 168 is frictionally engaged with the shaft 171 of the tripod male screw 17. The proximal end portion 168a is formed as an arc and frictionally contacts with the periphery of the shaft 171, so that when the tripod male screw 17 is rotated a rotational force is transmitted to the proximal end portion 168a in the same direction by the frictional force. On the other hand, since the arm 168 is disposed between a pair of narrow cylindrical stoppers 114, which are erected on the inside bottom face of the grip 11, a range where the arm 168 can be rotated with the tripod male a screw 17 by the frictional engagement is limited to the small angle between the stoppers 114. Further, on the distal end of the arm 168, a rotational stop claw 169 is rotatably supported. The rotational stop claw 169 includes a claw section 169a, which engages with the ratchet gear 164, and is rotatably supported by a pivot 168b provided on the distal end of the arm 168, and further the rotational stop claw 169 is biased by a coil spring 160, which is installed between the arm 168 and the rotational stop claw 169, in the direction engaging with the ratchet gear 164. However, the rotational motion caused by the biasing force due to the coil spring 160 is limited by a stop pin 168c erected on the arm 168. The rotational motion is limited at the position where it is required for the claw section 169w to engage with the ratchet gear 164 when the arm 161 is rotated in the clockwise direction of FIG. 4.

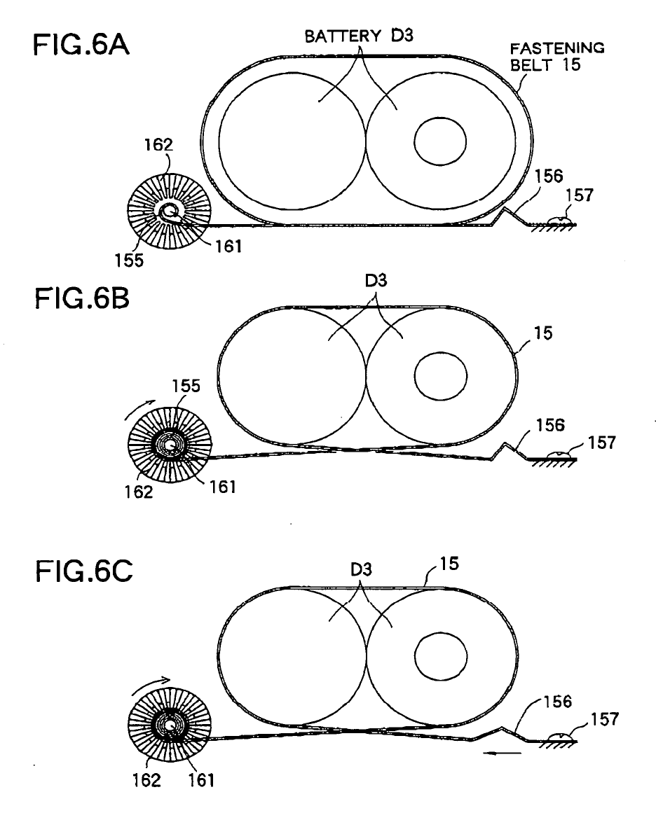

In the battery grip 10 of the above-described structure, the fastening bolts 15 are released when the battery grip 10 is removed from the camera body 1, as shown in FIG. 6A. Namely, the battery doors 113 are removed and the dry cells D3 are inserted through the openings 111, so that the dry cells D3 are laid on the battery-bearing ribs 122 and supported. On this occasion, each of the dry cells D3 is laid on the battery-bearing ribs 122 while pressing the contact piece 132 at the center with one side terminal of the dry cell D3 and elastically deforming the contact piece 132. Thereby, the dry cell D3 is retained between the contact pieces 131 and 133 provided on each side by the elastic restoring force of the contact pieces, so that each of the positive and negative terminals is electrically connected to the contact pieces 131-133. The battery doors 113 are then closed and the openings 111 are sealed to install the batteries. Namely, the processes are the same as those required in a conventional battery grip.

In order to mount the battery grip 10, in which the dry cells D3 are installed are described above, to the camera body 1, the upper surface of the battery grip 10 is abutted against the bottom surface of the camera body 1, and the tripod fastening knob 18 is rotated in the counterclockwise direction in FIGS. 3 and 5 (the direction is a clockwise direction in FIG. 4, so that in the following description, the explanation will be given based upon the direction in FIGS. 4A and 48), so that the tripod male screw 17 is threaded into the tripod female screw hole 7 by the rotational operation. At this time, the key 172 of the tripod male screw 17 is being fitted into the keyhole 163a of the first gear 163, so that the first gear 163 is rotated with the tripod male screw 17, and in turn, the second gear 165 and the third gear 166 are rotated by this rotational force. Further, the beveled gear 167 integrated with the third gear 166 rotates the fastening shaft 161 integrated with the beveled gear 162. Thereby, the fastening shaft 161 gradually winds up the one end 155 of each fastening belt 15, so that the diameter of the loop is reduced as the fastening belts 15 are fastened. Further, as described in FIG. 6B, the fastening belt 15 fastens two dry cells D3, which are arranged side by side, in a lump.

On this occasion, since the other end side portion 152 of the fastening belt 15 is inserted into the slit opening 153 provided on the one end side portion 151, the fastening force acting on the dry cells D3 is uniformly generated at both sides in the lateral direction of the other end side portion 152 along the longitudinal direction of the fastening belt 15, so that the fastening belt 15 contacts with the peripheral surface of the dry cells D3 in a stable manner with even surface contact. Further, since the fastening belts 15 are thin and flexible, the fastening belts 15 closely fit with the periphery of the dry cells D3 when it is fastened, so that the friction generated between the fastening belts 15 and the peripheral surface or the dry cells D3 is increased. Thereby, the motion of the dry cells D3 in the longitudinal direction (the lateral direction of the fastening belt 15) can be prevented.

When the tripod male screw 17 is fully threaded into the tripod female screw hole 7, and in turn the battery grip 10 is fixed to the camera body 1, the key 172 of the shaft 171 comes out from the keyhole 163 of the first gear 163 due to the axial movement of the tripod male screw 17. Before the key 172 comes out from the keyhole 163a, the arm 168, which is frictionally engaged with the shaft of the tripod male screw 17, rotates in the clockwise direction by a small angle, within the angle range defined by the stoppers 114, and the claw section 169a of the rotational stop claw 169 engages with the ratchet gear 164. The engagement is also maintained even after the key contact between the first gear 163 and the tripod male screw 17 is released, so that the counterclockwise rotation of the first gear 163 is prevented and the fastening of the dry cells D3 by the fastening belts 15 is maintained. Namely, the movement of the dry cells D3 is prevented.

When an amount of the rotation of the first gear 163 is large and the fastening shaft 161 is rotated correspondingly through each of the gears, an amount of the fastening belt 15 to be wound is increased, so that the winding force from the fastening shaft 161 continues to act on the fastening belt 15 even after the dry cells D3 are fastened. However, since the absorbing section 156, which is provided on the other end 154 of the fastening belt 15, is elastically deformed and extended by the winding force, as shown in FIG. 6C. Thereby, the fastening shaft 161 will not be subjected to an excessive load and in turn the dry cells D3 will not be subjected to an excessive fastening force. Further, when the rotation of the first gear 163 is stopped, the rotation of the ratchet gear 164 engaged with the rotational stop claw 169 is reversed to the amount of backlash between the ratchet gear 164 and the rotational stop claw 169, so that the fastening force can be reduced. However, on this occasion, the fastening force against the dry cells D3 is maintained by the spring restoring force at the absorbing section 156 of the fastening belt 15.

Consequently, when the battery grip 10 is fixed on the camera body 1, motion of the dry cells D3 in the longitudinal direction is prevented even when impact or oscillation acts on the camera, since four dry cells D3 are securely fixed onto the inner base plate 12 by fastening of the fastening belt 15. Thereby, the electric contact between each of the positive and negative terminals and the contact pieces 131-133 is maintained, so that the intermittent disconnection of a dry cell D3 is prevented. Further, weakening or the spring section or the contact pieces 131-133 due to movement of the dry cell D3 being subject to repeated impacts or oscillations does not occur, so that the contact of the contact pieces 131-133 with the terminals of the batteries is maintained.

When the fastening knob 18 is rotated in the counterclockwise direction, in order to remove the battery grip 10 from the camera body 1, the tripod male screw 17 is rotated and the threaded engagement with the tripod female screw hole 7 is released. At first, the counterclockwise rotation of the first gear 163 is suspended since the rotational stop claw 169 engages with the ratchet gear 164. However, when the arm 168 (which frictionally engages with the shaft 171 of the tripod male screw 17) is rotated in the counterclockwise direction (by a small degree within the angle range defined by the stoppers 144) together with the tripod male screw 17, the rotational stop claw 169 integrally rotates with the arm 168 and the engagement of the claw section 169a with the ratchet gear 164 is released, so that the suspended rotation of the ratchet gear 164 by the rotational stop claw is released, as described in FIG. 4B. Further, when the tripod male screw 17 is rotated and moved downwardly, the key 172 of the shaft 171 of the tripod male screw 17 again fits with the keyhole 163a of the first gear 163, so that the first gear 163 is rotated in the counterclockwise direction together with the tripod male screw 17. When the first gear 163 is rotated in the counterclockwise direction, the second gear 165 and the third gear 166 are rotated, and in turn, two beveled gears 167 and 162 are rotated, so that the fastening shaft 161 is rotated in the opposite direction and the dry cells D3 are released by loosening the fastening belt IS. Namely, the condition shown in FIG. 6A reappears. Thereby, the dry cells D3 can be taken out from the battery grip 10, as is similar to the conventional battery case.

In the above embodiment, two dry cells are fastened and fixed at the same time. However, the dry cells can also be fastened and fixed for each of the dry cells or three or more dry cells can also be fastened and fixed at the same time. Further, although two fastening belts are used in the present embodiment, the number of the fastening belts can also be one or more than two. Moreover, the batteries are not limited to the dry cells of the size AA, and batteries other than the dry cell size AA batteries can also be adopted, if they can be fixed by fastening the fastening belt.

In the present embodiment, the invention is applied to the battery grip of a camera. However, the invention can also be applied to a battery case of various types of electronic devices, which use batteries for a power source, if the rotational mechanism for the fastening belt is modified. For example, the fastening belt can also be structured so that the belt is simply fastened by the rotational operation of a knob. In this case, a lock mechanism to maintain the fastening condition of the fastening belt may be provided, so that the rotation is manually locked when fastening the belt and manually unlocked when it is required to release the fastening.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2005-035469 (filed on Feb. 14, 2005) which is expressly incorporated herein, by reference, in its entirety.

1. A battery fixing structure used in a battery housing structure that houses a battery in a battery case and which makes terminals of the battery electrically contact with contact pieces provided in the battery case, comprising:
a fastening belt that is looped so as to wind around a periphery of a battery when one end of said fastening belt is pulled, while the other end of said fastening belt is fixed to the battery case.

2. A structure according to claim 1, further comprising:
a fastening shaft that is connected to said one end of said fastening belt; and
a rotational mechanism that rotates said fastening shaft;
wherein said rotational mechanism winds up said one end to tension said fastening belt when rotating said fastening shaft in one direction, and winds off said one end when rotation said fastening shaft in the opposite direction.

3. A structure according to claim 2, wherein said fastening belt is formed as one end side, which corresponds to said one end, being wider than the other end side, which corresponds to said other end, and said one end side is provided with a slit opening in which said other end side is insertable, so that said other end side is inserted into said slit opening and said fastening belt forms a loop.

4. A structure according to claim 3, wherein an absorbing section is provided on said other end in order to give elasticity to said fastening belt in a longitudinal direction, said absorbing section being formed by bending said fastening belt in a belt thickness direction.

5. A structure according to claim 2, wherein said rotational mechanism comprises a fastening knob that is manually rotated, so that said fastening shaft is rotated by a rotational operation of said fastening knob.

6. A structure according to claim 5, wherein said rotational mechanism is provided with a stop mechanism that suspends the opposite rotation of said fastening shaft, and said stop mechanism releases the suspension when said fastening knob is subjected to a rotational operation that rotates said fastening shaft in the opposite direction.

7. A structure according to claim 6, wherein said stop mechanism comprises:
a ratchet gear that is integrally rotatable with said fastening knob;
a stop claw that engages with said ratchet gear to suspend a rotation of said ratchet gear; and
an arm that is connected to said stop claw and that is fictionally engaged with said fastening knob in both rotational directions, and said arm being rotatable within an angle that is required to release the engagement between said stop claw and said ratchet gear, and said arm being capable of rotating with a rotation of said fastening knob.

8. A structure according to claim 1, wherein said battery housing structure is structured as a battery grip that is mounted on a camera using a tripod male screw, anrd said fastening knob comprises said tripod male screw.

9. A structure according to claim 8, wherein said battery comprises a dry cell type battery, which comprises a terminal on both ends in a longitudinal direction of said battery, so that a part of said dry cell along the longitudinal direction is fastened by said fastening belt.
